(19) United States
(12) Patent Application Publication
(10) Pub. No.: US 2008/0083873 A1
(43) Pub. Date: Apr. 10, 2008

(54) DEVICE AND METHOD FOR INTRODUCING MULTIPLE LIQUID SAMPLES AT ATMOSPHERIC PRESSURE FOR MASS SPECTROMETRY

(76) Inventor: Matthew Giardina, St. Joseph, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/867,142

(22) Filed: Oct. 4, 2007

Related U.S. Application Data
(60) Provisional application No. 60/850,452, filed on Oct. 9, 2006.

(51) Int. Cl. H01J 49/42

(52) U.S. Cl. 250/283; 250/288

(57) ABSTRACT

A method and apparatus introduces a secondary spray of uncharged liquid droplets into a primary stream of electrosprayed droplets. Droplets and/or components dissolved in the secondary liquid become charged through interaction with the primary electrospray stream. This results in formation of gaseous ions of the secondary solution susceptible to electrospray ionization. The secondary solution may consist of a mixture of calibration or reference mass standards. Using pulsed gas nebulization, the secondary spray is pulsed into the primary electrospray spray stream at intervals synchronized with the data collection system. In a second embodiment, the device may consist of a plurality of secondary sprayers for multiplexed sample introduction. Each of the secondary sprayers are pulsed at different intervals synchronized with data collection. In a third embodiment, the secondary component consists of a capillary tube inserted into the primary electrospray stream of charged droplets to decouple the process of electrospray and sample introduction.

### CROSS-REFERENCE TO RELATED APPLICATIONS

This application claims priority under 35 U.S.C. §119(e) on U.S. Provisional Application No. 60/850,452 entitled DEVICE AND METHOD FOR INTRODUCING MULTIPLE LIQUID SAMPLES AT ATMOSHERIC FOR MASS SPECTROMETRY, filed on Oct. 9, 2006, by Matthew Giardina, the entire disclosure of which is incorporated herein by reference.

### BACKGROUND OF THE INVENTION

The present invention relates to mass spectrometers and particularly to an electrospray ion source utilizing a primary source and at least one secondary source.

Typically, specimens to be analyzed in a mass spectrometer, such as a time-of-flight mass spectrometer, are applied to an ion chamber for ionization utilizing either electrospray ionization (ESI) or matrix assisted laser desorption/ionization (MALDI). The specimens frequently are eluate from a liquid chromatograph and are supplied to an ion chamber at the inlet of the mass spectrometer through a nozzle with a nebulizing gas. A high voltage supply is coupled between the source of the liquid eluate and the mass spectrometer inlet nozzle to ionize the specimen. In order to calibrate the system, one or more calibration samples are infused together with the specimen or sample element (generally, mixing the sample and the calibrant and delivering in the same liquid stream is referred to as internal calibration). This may lead to an undesirable affect, of one solution with another. When calibration samples and unknown samples are run simultaneously, the signals from the unknown sample may be superimposed on the signal from the calibration standards, and it may become impossible to resolve the respective signals. With internal calibration, dilution of the eluate stream may occur leading to loss of low level sample detection. Also, ion suppression may occur when droplet size becomes too large.

Some attempts have been made to provide multiple electrospray sources utilizing multiple high voltage sources for the separate ionization of unknown samples and calibration samples, however, they are somewhat complex and require multiple voltage sources and/or additional baffle structure and, therefore, can become relatively expensive. There exists a need for an improved electrospray ionization system in which calibration samples and unknown specimens can be separately introduced into an ionization chamber, ionized, and introduced into a mass spectrometer.

### SUMMARY OF THE INVENTION

This invention, in one embodiment, includes a first spray nozzle coupled to a source of nebulization gas and a sample eluate, a second spray nozzle receiving a secondary or calibration liquid and oriented in a predetermined relationship to said first nozzle, a valve coupled to said source for selectively nebulizing the secondary or calibration liquid, and a high voltage ionization source coupled to said first spray nozzle. In another embodiment of the invention, the electrospray ionization system includes a first spray nozzle coupled to a source of nebulization gas and a primary electrospray liquid, a second spray nozzle receiving a first eluate, a first valve coupled to said source and to said second spray nozzle for selectively nebulizing said first eluate, a third spray nozzle receiving a second eluate, a second valve coupled to said source and to said third spray nozzle for selectively nebulizing said second eluate, wherein said first, second, and third nozzles are oriented in predetermined relationship to each other; and a high voltage ionization source coupled to said first spray nozzle. A further embodiment of the invention includes a spray nozzle coupled to a source of nebulization gas and a primary electrospray liquid, a capillary tube coupled to receive a sample eluate, wherein said capillary tube is oriented in a predetermined relationship to said spray nozzle, and a high voltage ionization source coupled to said spray nozzle.

The disclosed invention also provides a method of introducing a secondary spray of uncharged liquid droplets into a primary stream of electrosprayed droplets. Droplets and/or components dissolved in the secondary liquid become charged through interaction with the primary electrospray stream. The process results in the formation of gaseous ions for components of the secondary solution susceptible to electrospray ionization.

The invention has several applications as an atmospheric pressure ion source in mass spectrometry. In one application, the secondary solution may consist of a mixture of calibration or reference mass standards. Using gas nebulization, the secondary spray may be pulsed into the primary electrospray spray stream at intervals synchronized with the data collection system. This provides a method of automated mass calibration or reference mass correction for time-of-flight instruments.

The stability of electrospray is a problem in liquid chromatography mass spectroscopy (LC-MS) particularly when a gradient Is used. The second and third embodiments address this issue by forming the electrospray with the primary sprayer thereby decoupling the electrospray process from the liquid chromatography process. In a second embodiment of the invention, the device may consist of a plurality of secondary sprayers. Each of the secondary sprayers can be pulsed at different intervals synchronized with data collection. This system may be used for multiplexed sample introduction. In a third embodiment, the secondary component consists of a capillary tube inserted into the primary electrospray stream of charged droplets. Essentially, this decouples the process of electrospray and sample introduction.

The dual nebulizer provides an effective means of introducing a secondary stream of liquid droplets into a primary stream of electrosprayed droplets to reference correct time-of-flight mass spectra and reduce the effects of instrument drift.

These and other features, objects and advantages of the present, invention will become apparent upon reading the following description thereof together with reference to the accompanying drawings.

### BRIEF DESCRIPTION OF THE DRAWINGS

FIG. 1 is a pictorial view of a first embodiment of the invention;

FIGS. 2-4 are waveform diagrams of exemplary data collected by the mass spectrometer using the sample and calibration source introduction of this invention;

FIG. 5 is a snapshot continuum diagram taken at 5 minutes and 5.39 seconds of the detected elements from both the primary and secondary sprayers of the resulting waveform sample resolution available from the FIG. 1 embodiment;

FIG. 6 is a schematic view of a second embodiment of the invention;

FIG. 7 is a schematic view of a third embodiment of the invention; and

FIG. 8 is a block elevational circuit diagram of a control circuit for the systems of this invention.

### DETAILED DESCRIPTION OF THE PREFERRED EMBODIMENTS

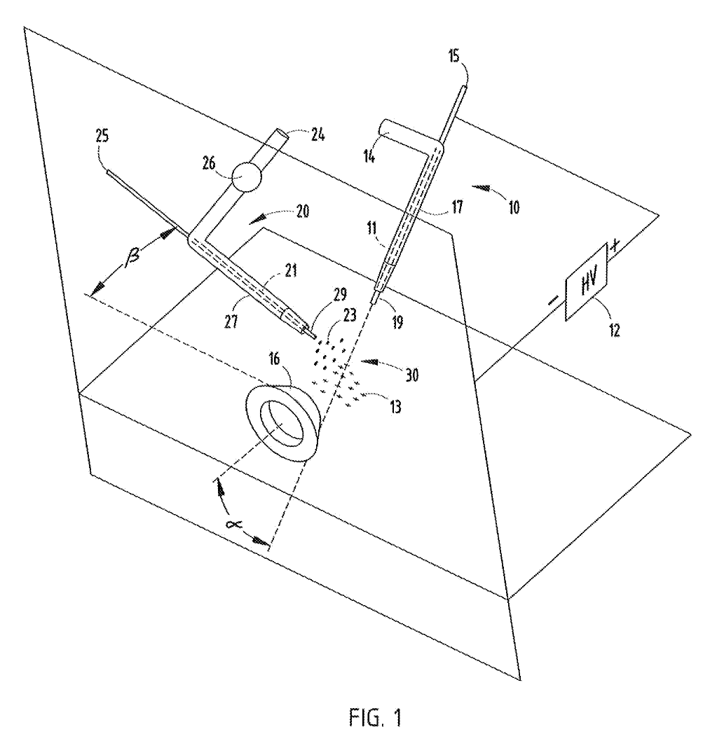

FIG. 1 is a first embodiment of the invention consisting of two spray nozzles 10 and 20 of conventional construction. The primary nozzle 10 forms ions through electrospray using a high voltage power supply 12 and may be combined with gas nebulization with a nebulizing gas, such as nitrogen (N₂), introduced at inlet 14 and heated desolvation to increase ion formation efficiency. An eluate stream from a chromatograph (not shown) is applied to nozzle 10 and capillary tube 11 through input 15. Source 12 is typically about 3500 VDC and is coupled between the primary nozzle 10 and the mass spectrometer inlet nozzle 16, as shown in FIG. 1.

The secondary spray nozzle 20 consists of a gas nebulizer with gas introduced at inlet 24. A calibration solution is supplied to sprayer 20 and capillary tube 21 through input 25 from a conventional source of desired calibration liquid, such as Agilent APCI tuning mix. The nebulizing gas is an inert gas, typically nitrogen. Intersection of the two generally orthogonal sprays 13 and 23 at area 30 yields the formation of gaseous ions of components dissolved in the secondary spray solution. The secondary sprayer illustrated in FIG. 1 is equipped with a valve 26 to interrupt the flow of nebulization gas. Interrupting the nebulization gas stops the secondary spray which, in turn, stops the formation of ions from the secondary solution. Nozzles 10, 20 are typically made including a center fused silica or stainless steel capillary tubes 11, 21 with an internal diameter of from about 20 μm to about 100 μm. The ends 19, 29 of capillary tubes 11, 21, respectively, are the emitters of the eluate stream and calibration fluid. The concentric nebulizer tubes 17, 27 are typically made of stainless steel with an inner diameter of about 650 μm and an outer diameter of about 900 μm. The ends of nebulizer tubes 17, 27 were constricted downwardly at their end to an internal diameter of about 250 μm over a length of about 2 mm. The nebulizer tubes are commercially available from Leco Corporation of St. Joseph, Mich., Part No. 709-086.

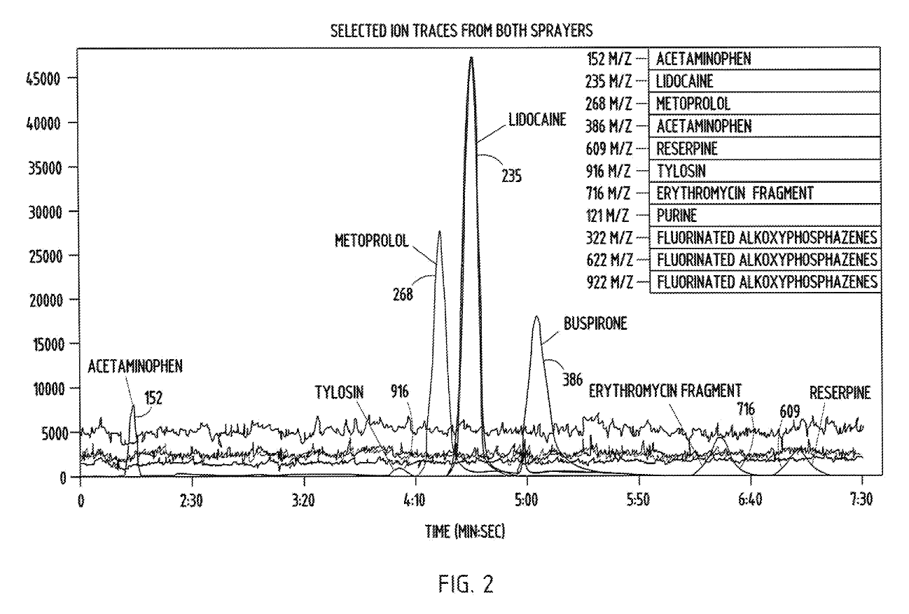

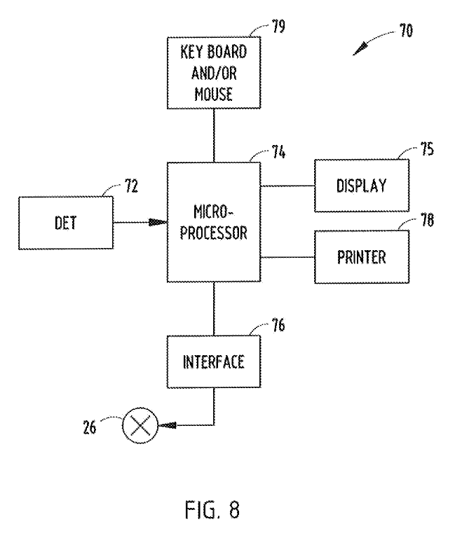

A conventional electrical control, circuit 70 (FIG. 8) is coupled to valve 26 to synchronize the actuation of valve 26 with the data collection system in a binary fashion to provide a method for automated mass calibration or reference mass correction. Control circuit 70 receives data from the detector 72 of the time-of-flight (TOF) mass spectrometer (not shown), which data is applied to an input of a microprocessor 74, which includes a memory for storage of collected data. Processor 74 is programmed to synchronize the actuation of valve 26 through an interface circuit 76 with the capture and display of data on display 75 and print out desired waveform diagrams, as seen in the diagrams of FIGS. 2-5 by printer 78. An operator interface, such as a keyboard and/or mouse 79 allows the operator to select operational modes of the system depending upon the specimen of interest and calibration material being used. The microprocessor may also be coupled to the chromatograph for controlling the introduction of eluate into spray nozzles 10 and 20. In the examples shown in FIGS. 2-5, the following parameters were employed:

Primary Nebulizer 10:
LC Conditions
   Eluate flow rate: 10 μl/min
   Mobile phase; 70% acetonitrile/30% water with 10 mM ammonium acetate, pH=5.0
   Injection volume: 100 nl
   Column: Zorbax SB-C18, 0.5×150 mm, 5 μm
Sample:
   Pharmaceutical mixture: acetaminophen, lidocaine, metoprolol, buspirone, reserpine, erythromycin, tylosin. Concentration˜10 μg/ml in water.
Electrospray Conditions:
   Electrospray voltage: 3500V
   Nebulizer pressure: 0 KPa
   Desolvation temperature; 100° C.
   Desolvation flow rate: 7.5 liters/min

Secondary Nebulizer 20:
Sample:
   Agilent APCI Tuning Mix—nominal mass/charge 121, 322, 622, 922, 1522, 2122, 2722
Conditions:
   Liquid flow rate: 10 μl/min
   Nebulizer pressure: 12 psi

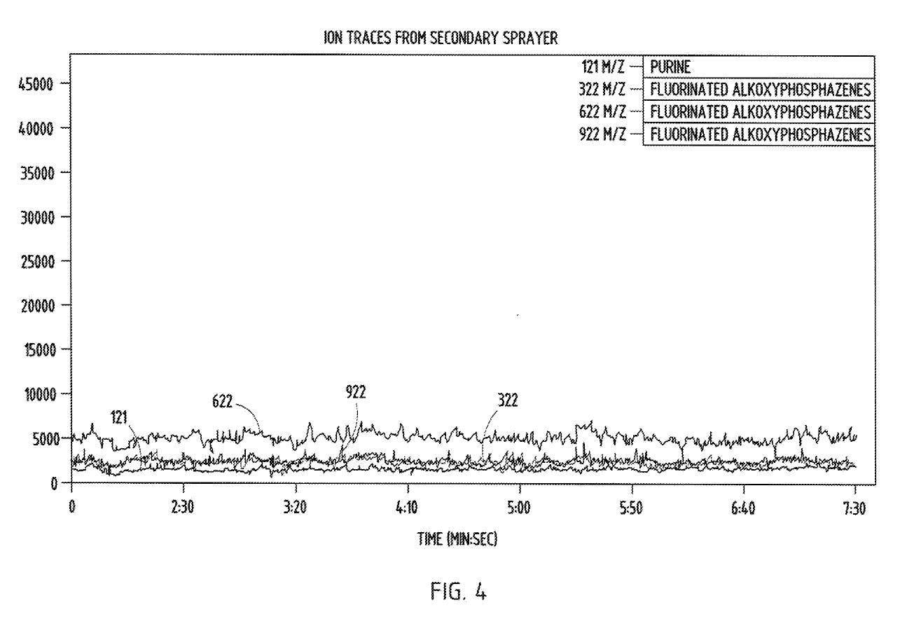

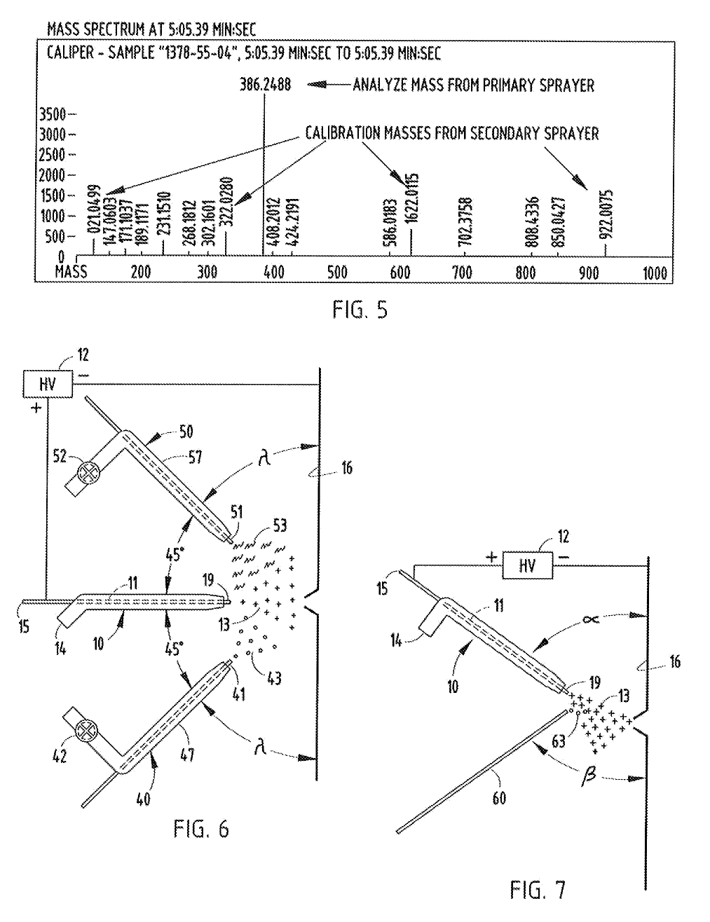

In the experimental data shown, valve 26 is not modulated. Valve 26 is open throughout data collection. In the FIG. 1 embodiment, the primary liquid consists of sample eluate from a liquid chromatograph undergoing electrospray ionization. At one time interval, the gas valve 26 is closed and the data system collects mass information of the liquid eluate. At a second time period, valve 26 is opened allowing the secondary calibration spray 23 to intersect the primary spray 13 at area 30. Mass information collected during this time interval is associated with the mass calibrants as seen in the example of FIGS. 2-5. The waveform diagrams of FIGS. 2-5 are representative of the operation of the FIG. 1 embodiment, although they represent the operation of the remaining embodiments shown in FIGS. 6 and 7.

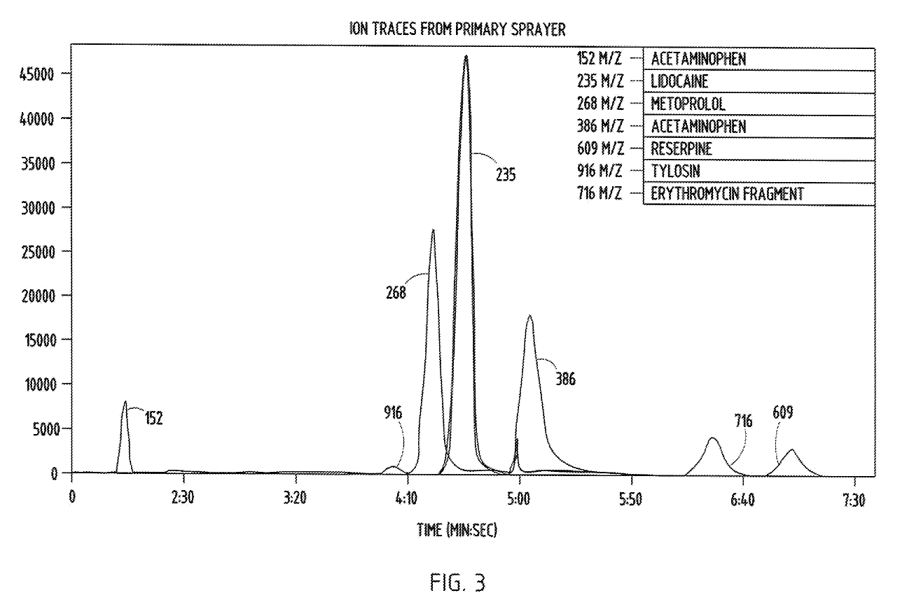

In FIG. 2, for example, the eluate stream for a period of 7 minutes 30 seconds includes a variety of pharmaceuticals, such as acetaminophen at 152 m/z, tylosin at 916 m/z, metroprolol at 268 m/z, lidocaine at 235 m/z, buspirone at 386 m/z, erythromycin fragment at 716 m/z, and reserpine at 609 m/z. Additionally, calibrants, such as purine at 121 m/z and various fluorinated alkoxyphosphazenes at 322, 622, and 922 m/z, are shown in the diagram of FIG. 2. The drugs are separated out in the FIG. 3 diagram, showing their respective peaks and mass units while the calibration samples are shown in FIG. 4. A snapshot of the acetaminophen peak, which occurred at approximately 5 minutes 5.39 seconds, is shown in FIG. 5, with the secondary nebulizer 20 also being shown in the expanded view of FIG. 5. The microprocessor 74 collects and stores the peak, data from detector 72 of the mass spectrometer and allows the operator to subsequently select, as seen in FIG. 5, data which may be of particular interest and expand the display of such data. The control circuit 70 allows the nebulizers (i.e., nozzles) 10, 20 to be simultaneously and/or separately and in timed sequence operated to introduce the primary eluate from the chromatograph and the calibration samples allow the accurate detection of the various analytes in the sample being analyzed.

Gating the secondary flow of spray nozzle 20 eliminates the affect, of ion suppression that would otherwise occur if the valve remained continuously open. Valve 26 is actuated numerous times at a predetermined rate throughout a chromatographic run. After the data is collected, the chromatogram can be reconstructed by the data system 70 (FIG. 8) to provide a continuous plot of corrected masses, as seen in FIGS. 2-5. In FIG. 1, the primary sprayer is oriented to the orifice plane of the mass spectrometer inlet, nozzle 16 at an angle α of from about 30° to about 45° and preferably about 30°. The secondary sprayer 20 is oriented to the plane of nozzle 16 at an angle β of from about 7° to about 17° and preferably about 12°.

FIG. 6 is a schematic view of the invention implemented with a plurality of spray nozzles, it being understood that the nozzles are oriented in a manner similar to that shown in FIG. 1. In FIG. 6, the primary spray 13 from nozzle 10 is an electrosprayed isocratic solution at constant composition (e.g. a solution 50% H₂O and 50% methanol and 0.1% acetic acid) while secondary sprays 43, 53 provide first and second solutions, respectively, through nozzles 40, 50, which are eluate from separate liquid chromatographic processes (e.g. gradient). The nozzles 40, 50 are constricted in a manner similar to nozzles 10, 20 and include capillary tubes 41, 51 concentrically positioned within outer tubes 47, 57 of the nozzles. The primary spray can be any solution that supports electrospray. Typically, the stability of electrospray is highly dependent on the composition of the solution. Thus, any solution that can supply a stable electrospray stream can be used. In this embodiment, the valves 42 and 52 are coupled to a control circuit similar to control circuit 70 and actuated at opposing intervals synchronized with the data acquisition system for multiplexed sample analysis. The advantage to this arrangement is the decoupling of the electrospray process from the separation process where electrospray and separation conditions can be optimized independently. In this embodiment, the primary spray nozzle 10 is normal to the plane of inlet nozzle 16 while secondary spray nozzles 40 and 50 are oriented at an angle λ of from about 30° to about 45° to the plane of nozzle 16.

FIG. 7 is another embodiment of the invention used as a decoupling system. A capillary tube 60 carries eluate 63 from a liquid chromatograph directly into the electrospray stream 13 of the primary sprayer 10 to ionize the eluate 63 and introduce the ionized particles into the nozzle 16 of the mass spectrometer. Nozzle 10 is oriented at angle α, as in the FIG. 1 embodiment. Capillary tube 60 is oriented at an angle β as in the FIG. 1 embodiment. The advantage to this design is the decoupling of electrospray and sample introduction processes.

An advantage of each of the systems of FIGS. 1 and 6-7 is that they employ a single high voltage power supply 12. Also, the mounting arrangements for the nozzle(s)/capillary tubes are less expensive and allows for easier optimization of the secondary sprayer(s).

It will become apparent to those skilled in the art that various modifications to the preferred embodiment of the invention as described herein can be made without departing from the spirit or scope of the invention as defined by the appended claims.

The invention claimed is:

1. An electrospray ionization system comprising:
a first spray nozzle coupled to a source of nebulization gas and having a sample eluate inlet for receiving a sample eluate;
a second spray nozzle having an inlet coupled to said source of nebulizing gas and an input for receiving one of a secondary and calibration liquid, said second nozzle oriented in a predetermined relationship to said first nozzle;
a valve coupled to said inlet, of said second spray nozzle for selectively nebulizing one of said secondary and calibration liquid; and
a high voltage ionization source coupled to said first spray nozzle.

2. The electrospray ionization system as defined in claim 1 and further including a mass spectrometer inlet nozzle and wherein said high voltage source is coupled between said first spray nozzle and said spectrometer inlet nozzle.

3. The electrospray ionization system as defined in claim 2 wherein said first spray nozzle is oriented at an angle α of from about 30° to about 45° with respect to the plane of said spectrometer inlet nozzle.

4. The electrospray ionization system as defined in claim 3 wherein said second spray nozzle is oriented at an angle β of from about 7° to about 12° with respect to the plane of said spectrometer inlet nozzle.

5. The electrospray ionization system as defined in claim 4 wherein the sprays from said first and second spray nozzles intersect and about 90°.

6. The electrospray ionization system as defined in claim 5 and further including a control circuit having data collection storage wherein said control circuit actuates said valve to synchronize the introduction of one of said secondary and calibration liquid with the collection of sample eluate data,

7. The electrospray ionization system as defined in claim 6 wherein the eluate flow rate in said first nozzle is about 10 μl/minute.

8. The electrospray ionization system as defined in claim 7 wherein the liquid flow rate in said second nozzle is about 10 μl/minute.

9. An electrospray ionization system comprising:
a first spray nozzle coupled to a source of nebulization gas and a primary electrospray liquid;
a second spray nozzle receiving a first eluate;
a first valve coupled to said source and to said second spray nozzle for selectively nebulizing said first eluate;
a third spray nozzle receiving a second eluate;
a second valve coupled to said source and to said third spray nozzle for selectively nebulizing said second eluate, wherein said first, second, and third nozzles are oriented in predetermined relationship to each other; and
a high voltage ionization source coupled to said first spray nozzle.

10. The electrospray ionization system as defined in claim 9 and further including a mass spectrometer inlet nozzle and wherein said high voltage source is coupled between said first spray nozzle and said spectrometer inlet nozzle.

11. The electrospray ionization system as defined in claim 10 wherein said first spray nozzle is oriented normal to the plane of said spectrometer inlet nozzle.

12. The electrospray ionization system as defined in claim 11 wherein said second spray nozzle is oriented at an angle λ of from about 30° to about 45° with respect to the plane of said spectrometer inlet nozzle.

13. The electrospray ionization system as defined in claim 12 wherein said third spray nozzle is oriented at an angle λ of from about 30° to about 45° with respect to the plane of said spectrometer inlet nozzle and about 90° to said second spray nozzle.

14. The electrospray ionization system as defined in claim 13 wherein said primary electrospray liquid is an isocratic solution.

15. The electrospray ionization system as defined in claim 14 wherein said first and second eluates are separate chromatograph samples.

16. An electrospray ionization system comprising:
a spray nozzle coupled to a source of nebulization gas and a primary electrospray liquid;
a capillary tube coupled to receive a sample eluate, said capillary tube oriented in predetermined relationship to said spray nozzle; and
a high voltage ionization source coupled to said spray nozzle.

17. An electrospray ionization method comprising the steps of:
providing a first spray nozzle with a source of nebulization gas and a sample eluate;
providing a second spray nozzle with a secondary or calibration liquid;
orienting said second spray nozzle in a predetermined relationship to said first nozzle;
providing a valve between said source and said second spray nozzle; and
coupling a high voltage ionization source to said first spray nozzle.

18. An electrospray ionization method comprising the steps of;
providing a first spray nozzle with a source of nebulization gas and a primary electrospray liquid;
providing a second spray nozzle with a first eluate;
providing a first valve between said source and said second spray nozzle for selectively nebulizing said first eluate;
providing a third spray nozzle with a second eluate;
orienting said first, second, and third nozzles in predetermined relationship to each other;
providing a second valve coupled to said source and to said third spray nozzle, for selectively nebulizing said second eluate; and
coupling a high voltage ionization source coupled only to said first spray nozzle.

19. An electrospray ionization method comprising:
providing a spray nozzle with a source of nebulization gas and a primary electrospray liquid;
providing a capillary tube coupled with a sample eluate;
orienting said capillary tube in predetermined relationship to said spray nozzle; and
coupling a high voltage ionization source coupled only to said spray nozzle.
